(19) United States
(12) Patent Application Publication
(10) Pub. No.: US 2008/0035149 A1
(43) Pub. Date: Feb. 14, 2008

(54) Respirators

(75) Inventor: Robert Charles Sutton, Southport Lancashire (GB)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCOTT HEALTH & SAFETY LTD., Skelmersdale, Lancashire (GB)

(21) Appl. No.: 10/598,921

(22) PCT Filed: Mar. 17, 2005
(86) PCT No.: PCT/GB05/50038

§ 371 Date: May 23, 2007

(30) Foreign Application Priority Data
Mar. 19, 2004 (GB) 0406288.1

(51) Int. Cl. A62B 9/02

(52) U.S. Cl. 128/205.24

(57) ABSTRACT

An exhalation valve assembly for a respirator, said assembly comprising an upstream one-way flap valve and a downstream one-way flap valve, both mounted within a housing. The valves are 5 spaced apart to define therebetween a volume which acts as a ‘dead space’ in which a portion of the just-exhaled air will rest so that, should the upstream valve leak for any reason, any leakage air drawn back into the respirator will be taken from this just-exhaled air, and will thus not be contaminated by the ambient air.

This invention relates to respirators and in particular to exhale valves for respirators.

A respirator is a piece of personal protective equipment designed to protect a wearer from inhaling harmful material present in the ambient air. Respirators may take the form of a simple mask, attached to the head by means of one or more straps, and which covers just the nose and mouth of the wearer. This type of mask is commonly referred to as an oronasal mask. A more sophisticated mask covers the whole of the wearer's face and often includes within it an oronasal mask, either as a separate mask within the main mask, or as a partitioned-off section of the main mask. Such masks are capable of giving improved protection over the simple oronasal mask. Another variant of respirator is the protective hood which encloses the head of the wearer, and is sealed around the neck. The final commonly-encountered variant of respirator is the protective suit which encloses the whole body of the wearer. Both the hood and suit variants may or may not incorporate oronasal masks.

All respirators have some features in common:

1) Means incorporating a filter for allowing inhaled air to enter the respirator from the exterior, and filtering such air as it enters to remove harmful material;

2) Seal means to prevent air from the exterior from being inhaled by the wearer other than that that has passed through the filter. In the case of a whole body suit, this is realised by making the suit as a sealed bag which encloses the wearer; in the case of a respirator which does not enclose the whole body, the seal means takes the form of a resilient lip, flange, cushion or equivalent which seals the locus of contact to the wearer.

3) A valve structure to allow exhaled air to exit the mask, but prevent air from entering the mask by the same pathway. This structure is normally referred to as an exhale valve and it is with this particular area of respirator design that the present invention is concerned.

The most common current design of exhale valve is a flap valve which comprises a valve element of elastomeric material which is loosely constrained in such a way that, in its normal position, it covers and seals the output orifice of the respirator through which the wearer exhales. When the wearer exhales, pressure rises within the mask and this causes the valve element to lift from its seating to allow the exhaled air to exit the respirator. At the termination of exhalation, the valve element returns to its normal position, thus sealing the output orifice and preventing harmful material from the exterior entering therethrough. During inhalation, the pressure within the respirator drops below that in the ambient atmosphere and the valve element is drawn against the seating thus, again, sealing the output orifice. An exhale valve of this type is described, for example, in GB-A-2222778.

Unfortunately, the sealing action of the valve element is not perfect and, particularly under certain conditions, such as windy ambient conditions or turbulence in the exhaled flow, the valve element can lift from its seating, either momentarily or in a semi-continuous rippling motion which can allow ambient air to flow through the valve in the reverse direction, and into the respirator. This is particularly dangerous during inhalation, during which time the pressure in the mask drops, thus tending to draw in air from the exterior via any available orifice.

In order to counter this difficulty some known respirators incorporate an arrangement defining a volume downstream of the exhale valve in which a portion of the air which has just been exhaled will rest. This volume is often referred to as a dead space. The purpose of the dead space is that, should the exhale valve leak for any reason, and air is drawn in the reverse direction through the valve, then the air which is drawn in will be the air which has just been exhaled, and should therefore not be contaminated.

In order to be effective, the dead space should, as far as possible, prevent the mixing of the ambient air with the exhaled air contained in the dead space. In current designs, the dead space is created by means of baffles or tortuous passages or other similar devices intended to briefly trap a proportion of the exhaled air immediately adjacent the downstream side of the valve. The volume of exhaled air which is trapped in this way does not need to be great, because the potential leakage is quite small, and the dead space is, of course, being regularly replenished at each exhale action of the wearer. However, to ensure that the dead space is effective even in extreme adverse conditions, the devices currently used tend to restrict the exhale airflow unduly, and thus increase the resistance to exhalation, resulting in increased discomfort for the wearer.

In the present invention we create a dead space volume by utilising a second valve downstream from the existing valve, thus eliminating the need for baffles, tortuous passages and similar devices. Thus, in the present invention the dead space effectively becomes the volume between the two valves.

In accordance with the invention there is provided an exhalation valve assembly for fitting in the exhalation path of a respirator, said valve assembly comprising first and second valves spaced apart in the exhalation path such as to define between them a dead space operable to retain a portion of the exhaled air.

Each of the valves is a one-way valve whose flow direction is such as to allow exhaled air to pass through the first and second valves in series, but not in the reverse direction. The valves should be spaced apart by an amount such as to create the desired dead space volume, subject to the valves being sufficiently far apart that they do not interfere with one another during their normal operation. In fact, it is thought that a distance apart which meets the latter requirement will create a dead space volume sufficient for most purposes—as has already been stated, the amount of exhaled air which needs to be retained does not need to be great.

The use of a second valve creates a very secure dead space with a considerably reduced likelihood of being compromised, even in extreme adverse conditions. This enhanced dead space is achieved whilst increasing the exhale resistance only by a relatively small amount, due to the second valve.

As mentioned, it is preferred that the two valves are mutually arranged such that they operate independently of one another. Thus the upstream valve functions as a true unidirectional exhale valve whereas the downstream valve acts to entrain a dead volume of exhaled air downstream of the upstream valve. An additional benefit of this arrangement is that the downstream valve can further act to compensate for small imperfections in the upstream valve.

In the currently preferred embodiment the two valves are of substantially identical construction, and are the same size. However this does not have to be the case, and an embodiment is also described in which the valve construction, although still of the flap-type, is different.

The downstream valve does introduce extra resistance in the exhale airflow; however this can be minimised by careful valve design, and attention to the shape of the air path between the two valves.

The particular construction of the first and second valves is not material to the invention, provided that they are both of the one-way (unidirectional) type. Commonly valves used for exhale valves are simple flap valves, as described above, and this construction of valve is satisfactory for the present invention. However, other constructions could be used. A particular type of flap valve, having a conical valve element, might be preferred for the downstream valve (which is more exposed to ambient conditions) since it is reckoned that this type of valve can be more resistant to headwind.

In order that the invention may be better understood, two embodiments thereof will now be described by way of example only and with reference to the accompanying drawings in which:

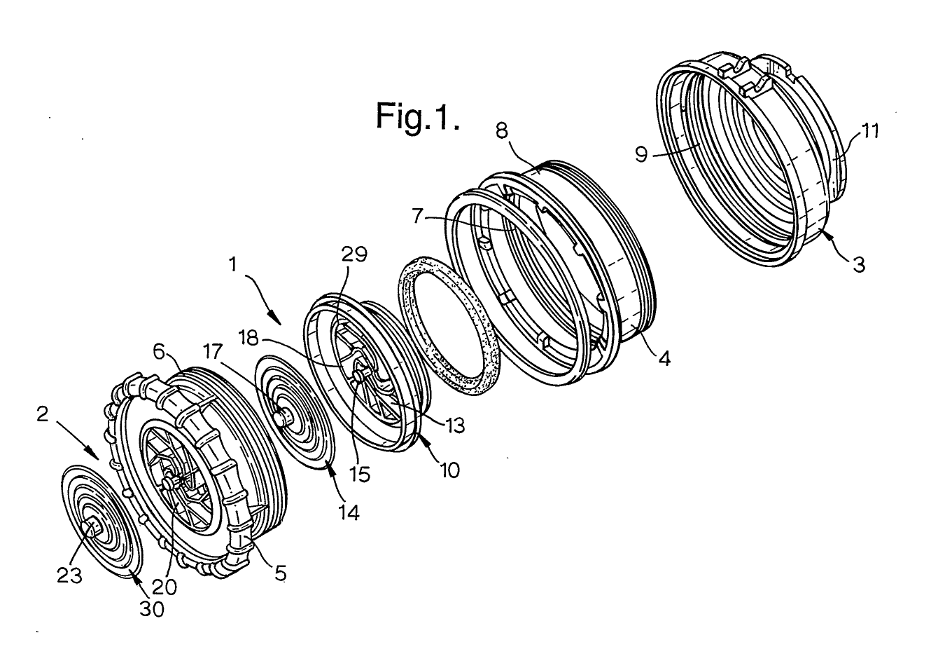

FIG. 1 is an exploded perspective view of a first embodiment of an exhale valve assembly according to the invention;

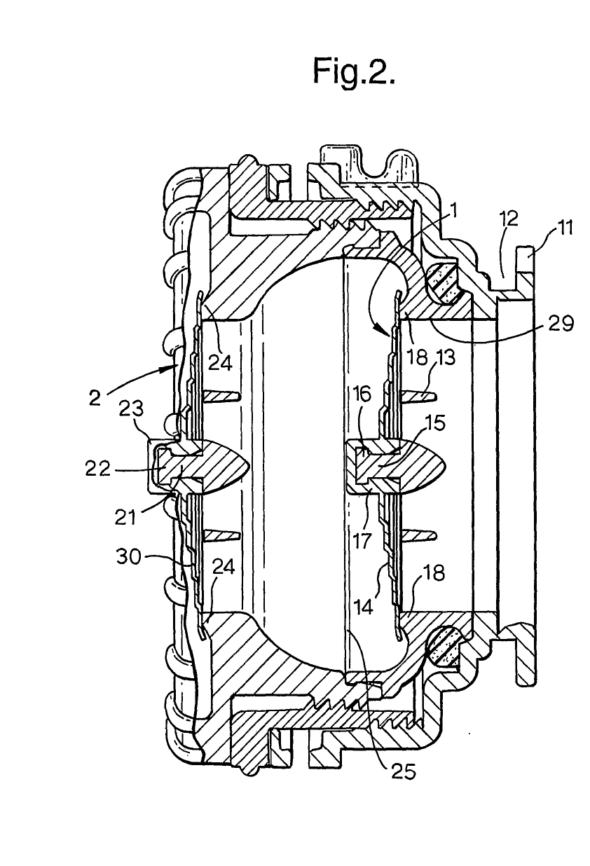

FIG. 2 is a sectional view of the exhale valve assembly of FIG. 1;

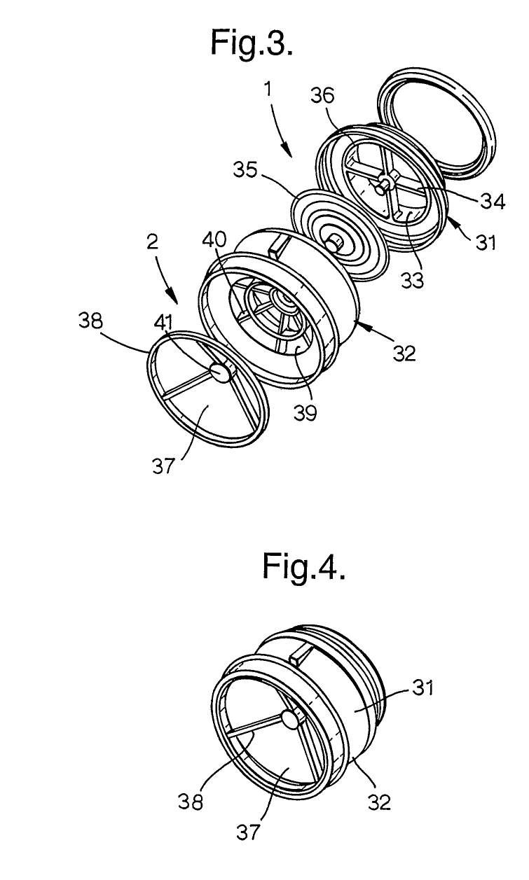

FIG. 3 is an exploded perspective view of a second embodiment of an exhale valve assembly according to the invention; and

FIG. 4 is a perspective view of the exhale valve of FIG. 3.

Referring to FIGS. 1 and 2, a first embodiment of the invention will now be described.

The exhale valve assembly comprises an upstream one-way valve shown generally under reference 1 and a downstream one-way valve shown generally under reference 2. Both valves are mounted within a housing comprising a cylindrical upstream section 3, a cylindrical intermediate section 4 and a cylindrical downstream section 5. The downstream section 5 is attached to the intermediate section 4 by cooperating male and female threads 6,7 and the intermediate section 4 is in turn attached to the upstream section 3 by cooperating male and female threads 8,9, thus trapping within the housing a seat member 10 for the upstream valve 1.

The upstream section 3 incorporates a flange 11 whereby the housing may be sealingly attached to the exhale orifice of the respirator (not shown). For example, the exhale orifice could be formed in an oronasal mask which is made of flexible material to enable the flange 11 to be slipped through the orifice so that the mask material becomes located in the annular groove 12 defined behind the flange 11.

The structure of the valves 1,2 is very similar. The upstream valve 1 comprises the aforementioned seat member 10 which is mounted within the housing. The seat member 10 defines an orifice 29 for the passage of exhaled air across which is fitted an open grid 13 to provide support for a valve member 14. The centre of the grid is formed with an upstanding peg 15 having an enlarged distal end 16. The valve member 14 takes the form of a circular disc made of elastomeric material such as silicone rubber, butyl rubber, natural rubber or isoprene. The centre of the disc is formed with a boss 17 in which is formed a closed bore having a shape which cooperates with that of the peg 15 to enable the disc to be securely fitted over the peg, and thus fixed in relation to the seat member 10.

As can be seen particularly in FIG. 2, the disc has a slightly curved profile whereby, close to its perimeter, it bears against an upstanding ridge 18 formed on the seat member 10. This ridge effectively forms the valve seat.

It will be seen that the valve member 14 blocks the flow of air from left to right in FIG. 2—i.e. the upstream direction. During exhalation, pressure within the mask will rise, and this rise in pressure causes the valve member to lift from its seat, thus allowing a flow of air from right to left in FIG. 2.

In the case of the downstream valve 3 the downstream section 5 forms the seat member and includes an orifice 19 for the passage of air across which is fitted an open grid 20 to provide support for a valve member 30. The centre of the grid 20 is formed with an upstanding peg 21 having an enlarged distal end 22 on which is mounted the valve member 30 by its boss 23, as before. The valve member 30 likewise, in its normal position, bears against an upstanding ridge 24 near its perimeter, the ridge 24 thus effectively forming a valve seat for the downstream valve.

It will be seen that, in between the valves 2,3 there is defined a volume 25 which is the dead space referred to above. Upon exhalation the valve 1 opens, as already explained, and this allows exhaled air to enter the volume 25, thus increasing the pressure in the volume 25 which tends to lift the valve member 30 of the downstream valve 2, thus allowing air to the exterior. When exhalation ceases, the pressure in the mask falls and the upstream valve 1 closes. The downstream valve 2 remains open for a short period until the pressure in the volume 25 falls to ambient whereupon the downstream valve 2 also closes. This leaves a portion of the just-exhaled air trapped in the volume 25. This air is isolated from the exterior by the valve 2 and thus cannot be contaminated by harmful materials present in the ambient air. In the event of leakage of the valve 1, for example during inhalation, the air which leaks across the valve 1 will be sourced from the volume 25 which contains only previously exhaled air. Even if the valve 2 leaks—for example due to the exterior conditions as discussed above—only a small amount of potentially contaminated air will enter the volume 25 and this will travel no further provided that the valve 1 is not simultaneously leaking. Any such contamination entering the volume 25 will be flushed out on the next exhalation. Thus only in the extreme condition of both valves leaking within the same exhalation/inhalation cycle will there be a danger of contamination from the exterior travelling upstream through both valves to the interior of the mask; if this event does occur, any harmful material travelling upstream will be considerably diluted by mixing with the exhaled air trapped in the volume 25 from the previous exhalation.

The use of the valve 2 downstream of the regular exhale valve 1 will, as explained above, increase the resistance to airflow of the exhale valve assembly as a whole and, in order to reduce this as much as possible, the internal surfaces of the passage between the two valves which forms the volume 25 are shaped to reduce resistance to air flow by avoiding, as far as possible, sharp corners and edges which might increase turbulence. This can be seen in particular in FIG. 2 in the smooth transition 41 made by the internal surface as it passes from the larger diameter existing at the output of the upstream valve 1 to the smaller diameter at the input of the downstream valve 2.

Although the use of a secondary valve, downstream of the first, is intended to create the required dead space discussed above, it would of course be possible to add some form of baffle or equivalent arrangement to create a second dead space downstream of the valve 2. However, tests suggest that this is not in fact necessary except perhaps in the most extreme or unusual circumstances.

Reference is now made to FIGS. 3 and 4 which illustrate a second embodiment of the invention.

The valves 1 and 2 of the exhale valve assembly of FIGS. 3 and 4 are housed in a housing comprising a cylindrical upstream section 31 and a cylindrical downstream section 32. Each section 31,32 acts as the seat member of a respective valve 1,2. Thus, the upstream section 31 is formed with an orifice 33 across which is formed an open grid through which exhaled air can flow. The centre of the grid is formed with an upstanding peg 34 which retains a valve member 35, in the same way as described above in relation to the first embodiment. In its normal position, the valve member 35 bears against an annular upstanding ridge 36 formed on the upstream section 31 around the edge of the orifice 33.

Thus it will be seen that the upstream valve 1 is of very similar construction to that of the corresponding valve in the first embodiment. The downstream valve 2, however, has a different construction, using instead of the approximately planar valve member 35, a conical valve member 37 which is supported in a frame 38 which fits in the front of the downstream section 32 of the housing. This type of valve member can give an improved resistance to lifting due to prevailing wind flow across the front of the valve. The downstream section 32 is formed with an orifice 39 across which is fitted a grid 40 in the manner described above. A central part of the grid 40 defines a bore into which a boss 41 forming part of the frame 38 may be inserted to securely locate the frame 38 and hence valve member 37 within the downstream section 32. The valve 2 is a flap valve and acts essentially in the same way as the upstream valve 1. The interior space between the two valves defines a dead space which acts in the same way as the corresponding dead space in the first embodiment.

Means (not shown) are provided on the upstream section 31 for enabling the attachment of the exhale valve to the respirator.

1. An exhalation valve assembly for fitting in the exhalation path of a respirator, said valve assembly comprising first and second valves spaced apart in the exhalation path such as to define between them a dead space operable to retain a portion of the exhaled air.

2. An exhalation valve assembly as claimed in claim 1 wherein each of said first and second valves is a one-way valve and wherein the valves are arranged such as to allow exhaled air to pass through them in series.

3. An exhalation valve assembly as claimed in claim 1 wherein said first and second valves are spaced apart a sufficient distance that they do not interfere with one another during their normal operation.

4. An exhalation valve assembly as claim 1 wherein each of said first and second valves comprise flap valves.

5. An exhalation valve assembly as claimed in claim 1 wherein the valves are situated within a generally cylindrical housing having means whereby it may be releasably attached to a respirator.

6. An exhalation valve assembly as claimed in claim 5 wherein said first and second valves are mounted across the interior of the cylindrical housing and spaced from one another so that the space within the cylindrical housing which lies between said valve constitutes said dead space.

7. An exhalation valve assembly as claimed in claim 1 wherein said housing is fabricated from separate cylindrical sections attached together, and wherein each of said valves is mounted in a respective one of said sections.

8. An exhalation valve assembly as claim 5 wherein the interior surface of the housing in the area between the first and second valves is smoothly contoured to minimise turbulence as the air passes from one valve to the other.

9. An exhalation valve assembly as claimed in claim 8 wherein the downstream valve has a valve member of conical or part-conical shape.

10. An exhalation valve assembly claim 1 further comprising baffle means situated downstream of the downstream valve to create a second dead volume downstream of the downstream valve.
